(19) United States
(12) Patent Application Publication
(10) Pub. No.: US 2024/0191830 A1
(43) Pub. Date: Jun. 13, 2024

(54) MONITOR SUPPORTING DEVICE

(71) Applicant: ADVANTECH CO., LTD., Taipei (TW)

(72) Inventors: Wen-Yu LIAO, Taipei (TW); Kai-Jen LI, Taipei (TW); Hsiao-Yun YUAN, Taipei (TW)

(21) Appl. No.: 18/531,867

(22) Filed: Dec. 7, 2023

(30) Foreign Application Priority Data
Dec. 9, 2022 (TW) 111147389

(51) Int. Cl. F16M 11/10; G06F 1/16; H02G 11/00

(52) U.S. Cl. CPC F16M 11/10; G06F 1/1601; H02G 11/006; F16M 13/02

(57) ABSTRACT

A monitor supporting device includes an arm module, a connection module, and a pivoting module. The connection module includes a main plate body adapted to be secured to an arm-securing portion of a monitor, and a cable-fixing unit connected to the main plate body. The cable-fixing unit includes an extension arm body that defines a constraining space adapted for passage of a plurality of cables therethrough, and that is adapted for allowing a cable tie to tie and secure the cables thereonto. The pivoting module is connected to the arm module and the main plate body, such that the connection module is pivotable relative to the arm module. A junction of the pivoting module and the main plate body is disposed above the extension arm body.

### CROSS-REFERENCE TO RELATED APPLICATION

This application claims priority to Taiwanese Invention Patent Application No. 111147389, filed on Dec. 9, 2022, the entire disclosure of which is incorporated by reference herein.

### FIELD

The disclosure relates to a supporting device, and more particularly to a monitor supporting device.

### BACKGROUND

A monitor for medical equipment is connected to a plurality of cables for transmitting power or signals, and is rotatable in different directions for convenience of viewing. When the monitor rotates, the cables may bend and press against each other, and when the monitor rotates more drastically, wires inside the cables may be damaged from being bent too much (bent in a 90 degree angle or more), or electric connectors of the cables may come loose, thus rendering the cables unable to transmit signals, and causing the monitor to be unable to display. Furthermore, when the cables are disorganized and scattered, the cables may come into contact with patients or caretakers, and become mediums for spreading infectious viruses.

### SUMMARY

Therefore, an object of the disclosure is to provide a monitor supporting device that can alleviate at least one of the drawbacks of the prior art.

According to the disclosure, the monitor supporting device is adapted for connecting with a back housing of a monitor. The back housing has an arm-securing portion, and a plurality of cable ports that are disposed below the arm-securing portion for connection to a plurality of cables. The monitor supporting device includes an arm module, a connection module, and a pivoting module. The connection module includes a main plate body and a cable-fixing unit. The main plate body is adapted to be secured to the arm-securing portion. The cable-fixing unit is connected to the main plate body, and includes an extension arm body. The extension arm body defines a constraining space adapted for passage of the cables therethrough, and is adapted for allowing a cable tie to tie and secure the cables thereonto. The pivoting module is connected to the arm module and the main plate body, such that the connection module is pivotable relative to the arm module. A junction of the pivoting module and the main plate body is disposed above the extension arm body.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an embodiment of a monitor supporting device according to the disclosure connected to a monitor.

FIG. 2 is a fragmentary perspective view of the embodiment.

FIG. 3 is a side view of a connection module of the embodiment.

FIG. 4 is a fragmentary side view of the embodiment connected to the monitor, with the monitor pivoted downwardly.

FIG. 5 is a fragmentary side view of the embodiment connected to the monitor, with the monitor pivoted upwardly.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

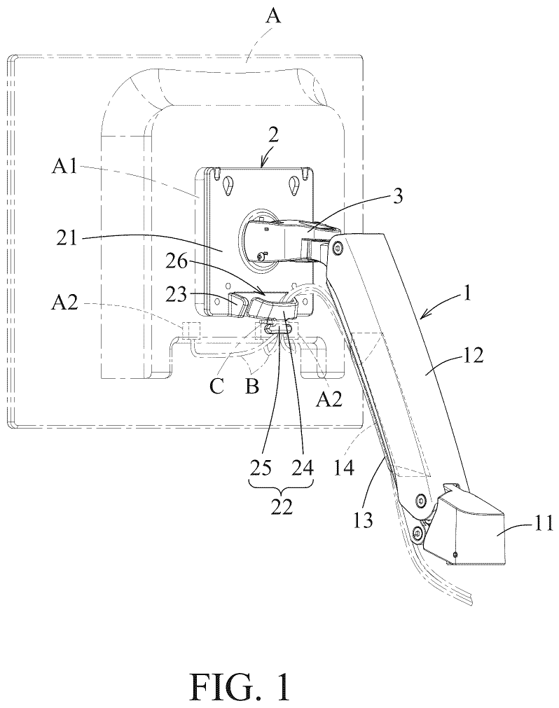

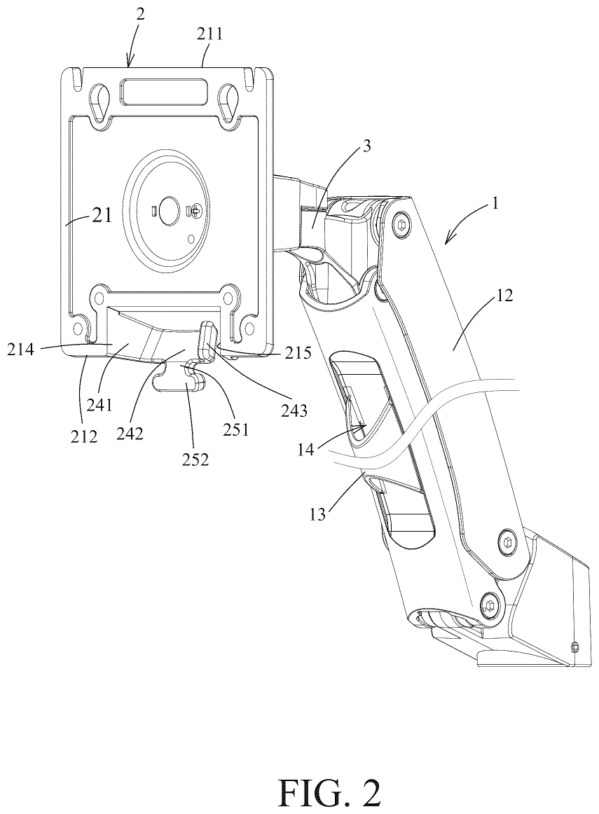

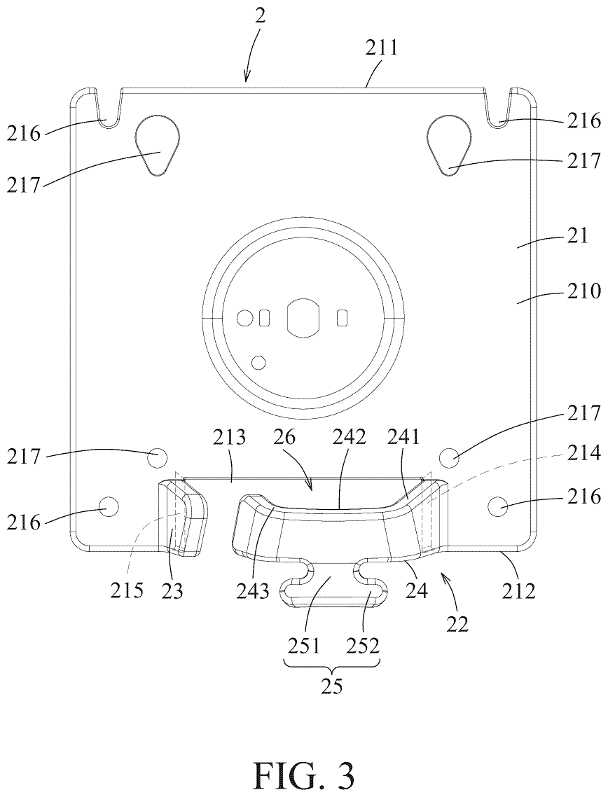

Referring to FIGS. 1 to 3, an embodiment of a monitor supporting device according to the disclosure is adapted for connecting with a back housing (A) of a monitor. The back housing (A) has an arm-securing portion (A1), and a plurality of cable ports (A2) that are disposed below the arm-securing portion (A1) for connection to a plurality of cables (B). The monitor supporting device includes an arm module 1, a connection module 2, and a pivoting module 3.

In this embodiment, the arm module 1 includes a fixing seat 11, a supporting arm 12, and a curved wall 13. The fixing seat 11 may be fixed to, for example, a frame of a cart (not shown). The supporting arm 12 is pivotably connected to the fixing seat 11. The curved wall 13 is connected to the supporting arm 12, and cooperates with the supporting arm 12 to define a cable passage 14 adapted for passage of the cables (B) therethrough so that the cables (B) may be tied and secured onto the supporting arm 1.

The connection module 2 includes a main plate body 21 adapted to be secured to the arm-securing portion (A1), a cable-fixing unit 22 connected to the main plate body 21, and a shielding block 23.

The main plate body 21 is square-shaped, and has a top edge 211, a bottom edge 212 that is opposite to the top edge 211, a recess 213 that extends from the bottom edge 212 towards the top edge 211, a plate body surface 210 that extends from the top edge 211 to the bottom edge 212 and that is formed with the recess 213, and a first inner side wall 214 and a second inner side wall 215 that are respectively adjacent to opposite ends of the recess 213. In this embodiment, the main plate body 21 has four first mounting holes 216 and four second mounting holes 217. The first mounting holes 216 are arranged respectively at four corners of an imaginary first square. Each side of the first square has a length of 100 mm, and two of the first mounting holes 216 are disposed lower than another two of the first mounting holes 216. The second mounting holes 217 are arranged respectively at four corners of an imaginary second square surrounded by the first square. Each side of the second square has a length of 75 mm, and two of the second mounting holes 217 are disposed lower than another two of the second mounting holes 217. The recess 213 is disposed below the two of the second mounting holes 217, and between the two of the first mounting holes 216. The monitor (A) has a plurality of monitor mounting holes formed in the back housing (A1) and arranged in one of two preset hole patterns (100 mm and 75 mm) that respectively correspond to the arrangements of the first mounting holes 216 and the second mounting holes 217. Specifically, when the monitor has a 100 mm preset hole pattern, the monitor may be screwed to the main plate body 21 via the first mounting holes 216; when the monitor has a 75 mm preset hole pattern, the monitor may be screwed to the main plate body 21 via the second mounting holes 217.

The cable-fixing unit 22 includes an extension arm body 24, and a positioning block 25 downwardly extending from the extension arm body 24. In this embodiment, the extension arm body 24 is disposed on the main plate body 21, is connected to the first inner side wall 214, extends towards the second inner side wall 215, and has a distal end that is spaced apart from the second inner side wall 215. The extension arm body 24 defines a constraining space 26 adapted for passage of the cables (B) therethrough, and is adapted for allowing a cable tie (C) to tie and secure the cables (B) thereonto. Specifically, the extension arm body 24 has a fixed portion 241, an intermediate portion 242, and a tail portion 243. The fixed portion 241 is disposed on the main plate portion 21, is connected to the first inner side wall 214, extends substantially towards the second inner side wall 215, and is inclined relative to the plate body surface 210. The intermediate portion 242 extends from the fixed portion 241, and is parallel to the plate body surface 210 in a direction from the first inner side wall 214 to the second inner side wall 215. The tail portion 243 extends from the intermediate portion 242 towards the recess 213, is inclined relative to the plate body surface 210, and is spaced apart from the second inner side wall 215, so that the cables (B) may pass through a gap between the tail portion 243 and the second inner side wall 215 and into the constraining space 26. The extension arm body 24 is disposed below the two of the second mounting holes 217, and between the two of the first mounting holes 216; i.e., the position of the extension arm body 24 corresponds to the position of the recess 213.

The positioning block 25 downwardly extends from the intermediate portion 242, and has a neck portion 251 that is connected to the intermediate portion 242, and a shoulder portion 252 that extends downwardly from the neck portion 251 and that has a width greater than a width of the neck portion 251. The positioning block 25 has an inverted T shape, and is adapted for allowing the cable tie (C) to tie and secure the cables (B) thereonto. Specifically, the intermediate portion 242 and the shoulder portion 252 secure the cable tie (C) onto the neck portion 251, thereby fixing a position of the cables (B). In other embodiments, the positioning block 25 may be omitted and the cable tie (C) may tie and secure the cables (B) directly onto the extension arm body 24; however, by utilizing the positioning block 25, tying and securing the cables (B) onto the cable-fixing unit 22 is easier and yields better securing effects.

The shielding block 23 is disposed on the main plate body 21, is connected to the second inner wall 215, is inclined relative to the plate body surface 210, and is substantially parallel to and spaced apart from the tail portion 243 of the extension arm body 24. Such configuration prevents the tail portion 243 from directly receiving external lateral forces that may damage the extension arm body 24.

The pivoting module 3 is connected to the arm module 1 and the main plate body 21, such that the connection module 2 is pivotable relative to the arm module 1. The pivoting module 3 and the fixing seat 11 are connected respectively and pivotably to opposite ends of the supporting arm 12. A junction of the pivoting module 3 and the main plate body 21 is disposed above the extension arm body 24. In this embodiment, the pivoting module 3 may pivot leftwardly, rightwardly, upwardly, and downwardly.

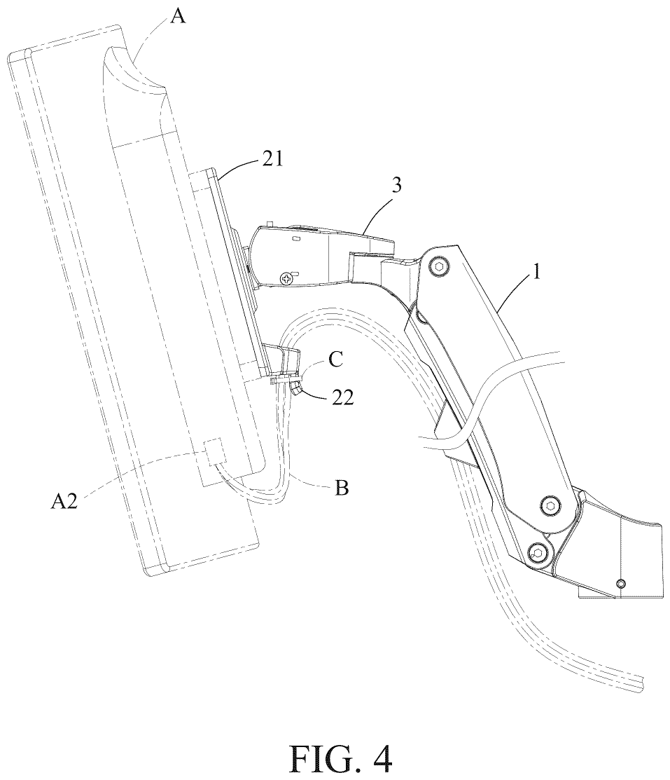

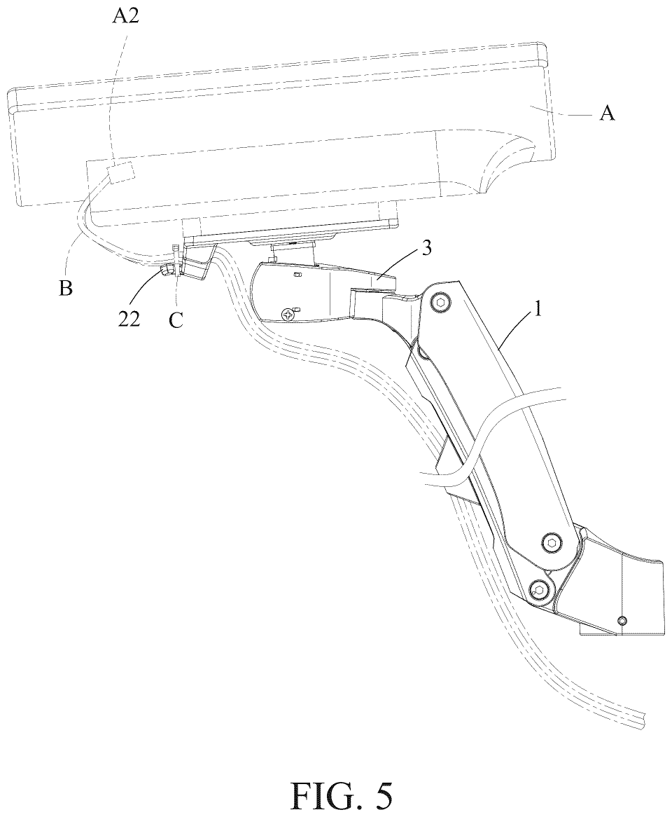

Referring to FIGS. 4 and 5, when the back housing (A) pivots downwardly (see FIG. 4) or upwardly (see FIG. 5) together with the monitor, by tying and securing the cables (B) to the cable-fixing unit 22, the length and the position of the portion of the cables (B) between the cable-fixing unit 22 and the cable ports (A2) are fixed, preventing the cables (B) from being pulled or bent and being disconnected from the cable ports (A2), thereby maintaining a steady display signal transmission for the monitor. Furthermore, if the back housing (A) further has a waterproof cover (not shown) for covering the cable ports (A2), when the monitor pivots, the cables (B) are in tight contact with the waterproof cover since the portion of the cables (B) between the cable-fixing unit 22 and the cable ports (A2) is fixed, thereby achieving better waterproof effects.

Moreover, when the monitor supporting device is used on a piece of medical equipment, by tying and securing the cables (B) to the cable-fixing unit 22, the cables (B) may be easily gathered, pass through the cable passage 14 and run along the supporting arm 12, reducing a chance that the cables (B) may come into contact with caretakers or patients, thereby reducing a risk of the cables (B) becoming a medium for spreading infectious viruses and promoting infection control.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A monitor supporting device adapted for connecting with a back housing of a monitor, the back housing having an arm-securing portion, and a plurality of cable ports that are disposed below the arm-securing portion for connection to a plurality of cables, said monitor supporting device comprising:
an arm module,
a connection module that includes
a main plate body adapted to be secured to the arm-securing portion, and
a cable-fixing unit connected to said main plate body, and including an extension arm body that defines a constraining space adapted for passage of the cables therethrough, and that is adapted for allowing a cable tie to tie and secure the cables thereonto; and
a pivoting module that is connected to said arm module and said main plate body, such that said connection module is pivotable relative to said arm module, a junction of said pivoting module and said main plate body being disposed above said extension arm body.

2. The monitor supporting device as claimed in claim 1, wherein said cable-fixing unit further includes a positioning block downwardly extending from said extension arm body, and adapted for allowing the cable tie to tie and secure the cables thereonto.

3. The monitor supporting device as claimed in claim 2, wherein:
said main plate body has
a top edge,
a bottom edge that is opposite to said top edge,
a recess that extends from said bottom edge towards said top edge, and
a first inner side wall and a second inner side wall that are respectively adjacent to opposite ends of said recess; and
said extension arm body is disposed on said main plate body, is connected to said first inner side wall, extends towards said second inner side wall, and has a distal end that is spaced apart from said second inner side wall.

4. The monitor supporting device as claimed in claim 3, wherein:
said main plate body further has a plate body surface extending from said top edge to said bottom edge and formed with said recess;
said extension arm body has
a fixed portion disposed on said main plate portion, connected to said first inner side wall, extending substantially towards said second inner side wall, and being inclined relative to said plate body surface,
an intermediate portion extending from said fixed portion, and being parallel to said plate body surface in a direction from said first inner side wall to said second inner side wall, and
a tail portion extending from said intermediate portion towards said recess, being inclined relative to said plate body surface, and being spaced apart from said second inner side wall; and
said positioning block downwardly extends from said intermediate portion.

5. The monitor supporting device as claimed in claim 4, wherein said positioning block has a neck portion that is connected to said intermediate portion, and a shoulder portion that extends downwardly from said neck portion, and has a width greater than a width of said neck portion.

6. The monitor supporting device as claimed in claim 4, wherein said connection module further includes a shielding block disposed on said main plate body, connected to said second inner side wall, being inclined relative to said plate body surface, and being substantially parallel to and spaced apart from said tail portion of said extension arm body.

7. The monitor supporting device as claimed in claim 1, wherein said arm module has a cable passage adapted for passage of the cables therethrough.

8. The monitor supporting device as claimed in claim 7, wherein said arm module includes:
a fixing seat,
a supporting arm pivotably connected to said fixing seat, and
a curved wall connected to said supporting arm, and cooperating with said supporting arm to define said cable passage; and
said pivoting module and said fixing seat are connected respectively and pivotably to opposite ends of said supporting arm.

9. The monitor supporting device as claimed in claim 1, wherein
said main plate body has
four first mounting holes arranged respectively at four corners of a first square, each side of the first square having a length of 100 mm, two of said first mounting holes being disposed lower than another two of said first mounting holes, and
four second mounting holes arranged respectively at four corners of a second square surrounded by the first square, each side of the second square having a length of 75 mm, two of said second mounting holes being disposed lower than another two of said second mounting holes; and
said extension arm body is disposed below said two of said second mounting holes, and between said two of said first mounting holes.
